(19) United States
(12) Patent Application Publication
(10) Pub. No.: US 2002/0183661 A1
(43) Pub. Date: Dec. 5, 2002

(54) Exercising tool for acupressure

(76) Inventor: Dong-Hoon Yoo, Seoul (KR)

Correspondence Address: Richard M. Goldberg, Suite 419, 25 East Salem Street, Hackensack, NJ, 07601, US

(21) Appl. No.: 09/924,655

(22) Filed: Aug. 8, 2001

(30) Foreign Application Priority Data
Jun. 1, 2001 (KR) 2001-16320

(51) Int. Cl. A61H 1/00

(52) U.S. Cl. 601/23

(57) ABSTRACT

An exercising tool for acupressure includes a curved surface with a plurality of acupressure protuberances on the upper side, a space at one part of the curved surface, a gripe being at one side of the space, the gripe being a circular rod in shape, and having a plurality of acupressure protuberances made of nonferrous metals, two rollers inserted into two inserting grooves respectively at the lower side of the curved surface, and the rollers being fixed with screws and fixing strips; and a sliding control protuberance rod at the lower side of the curved surface.

### BACKGROUND OF THE INVENTION

1. Field of the Invention

The present invention relates to an exercising tool for acupressure and more particularly, to an exercising tool for acupressure with which users exercise the whole body including strengthening muscles of the stomach, the sides, the chest, the shoulders, etc. Holding the gripes of each tools having a plurality of protuberances with both hands, respectively provides users with pressure-stimulation effects and encourages blood circulation by creating negative ion. Also, if users keep rolling the present tool forwardly and backwardly repeatedly with their knees at the ground and the palm of both hands on the curved surface with a plurality of protuberances, this movement offers users effects of exercising the whole body including strengthening muscles of the stomach, the sides, the chest, the shoulders, etc.

2. Description of the Prior Art

There are a lot of tools for exercising the arm, but the most commonly used one is a calisthenic iron dumbbell made of metals with both circular typed sides. Since the dumbbell is made of metals and used only for strengthening muscles of the arms, the dumbbell has no other exercising effects except arm exercises. There are also other kinds of exercising tools for the stomach, the sides, the chest, and the shoulders, respectively, but they have just their own exercise effects. In order to provide users more than one exercising effect at the same time, it is needed to combine one exercising tool which have one exercise effect with another exercising tool which have another exercise effect. But it requires high costs and a large space where the combined device is located.

### SUMMARY OF THE INVENTION

The present invention was designed to solve the problems as described above. The object of the present invention is to provide users with not only arm exercise effect but also other kinds of exercise effects at the same time. The present invention provides users with acupressure-stimulation effects due to a plurality of acupressure protuberances of nonferrous metals on the surface. T he present invention al so encourages blood-circulation by creating negative ion. Further, the present invention offers users effects of exercising the whole body including strengthening muscles of the stomach, the sides, the chest, the shoulders, etc by rolling this device forwardly and backwardly by the roller inserted inside the lower side of the invention, with the both palm of the hand on the curved surface of the present invention, and both knees on the ground.

### BRIEF DESCRIPTION OF THE DRAWINGS

The other objects and features of the present invention will be hereinafter explained in detail with reference to the accompanying drawings, wherein:

FIG. 1 is a perspective view of the present invention.

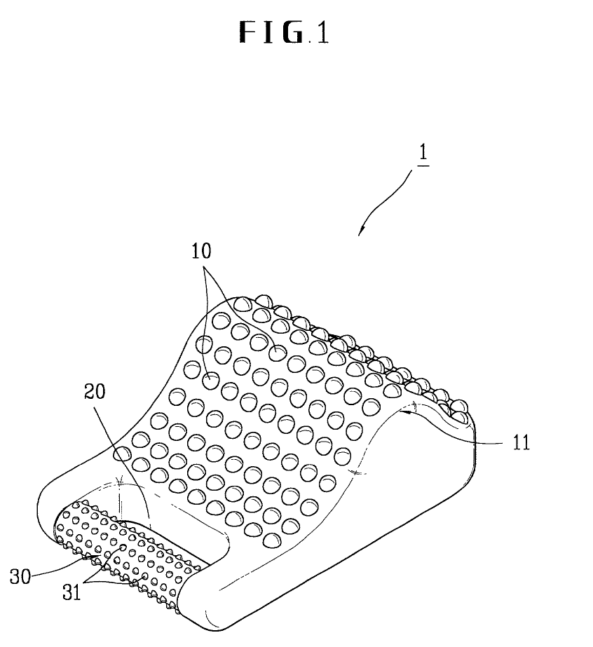

FIG. 2 is a partial disassembled perspective view of the upper part of the present invention.

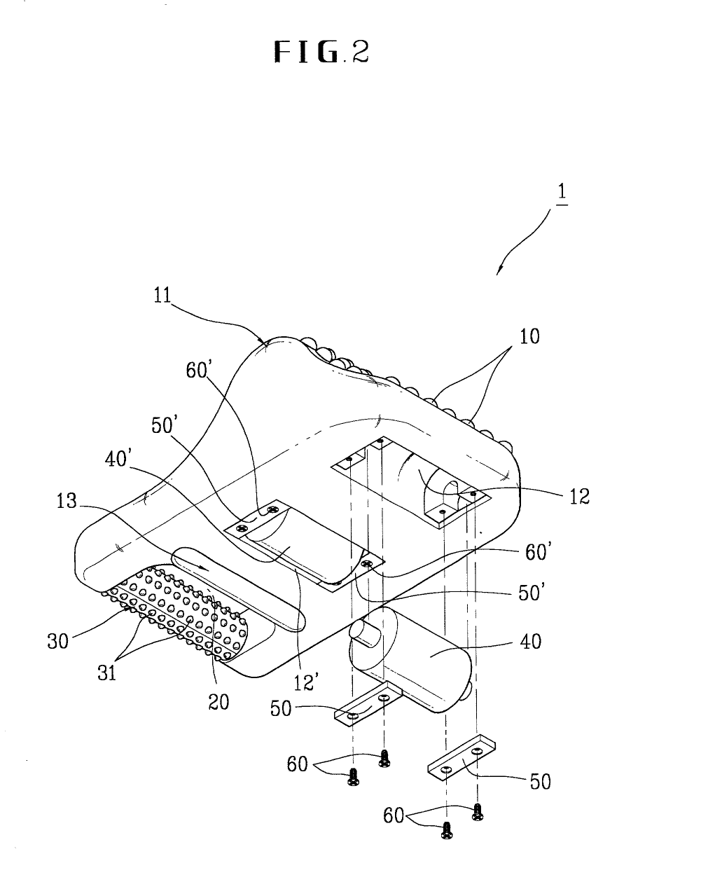

FIG. 3 is a cross-sectional view of the present invention.

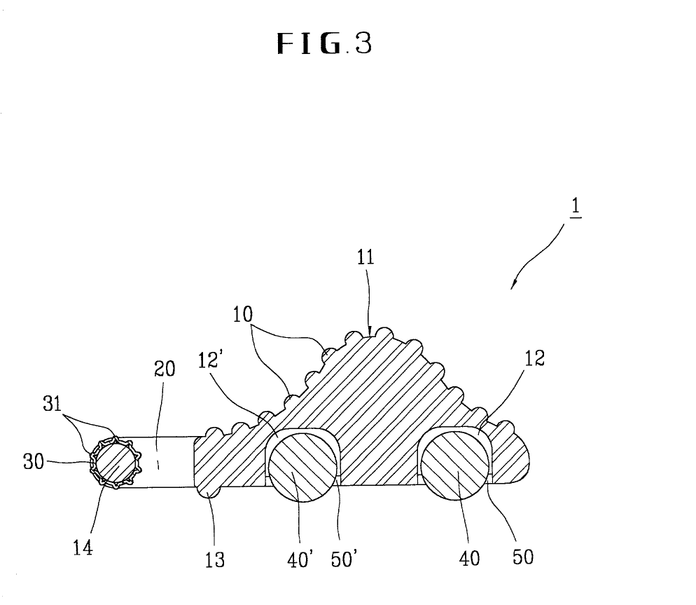

FIG. 4 is a view of an embodiment of the present invention.

FIG. 5 is a view showing a status before a sliding exercise with the present invention.

FIG. 6 is a view showing a status during a sliding exercise with the present invention.

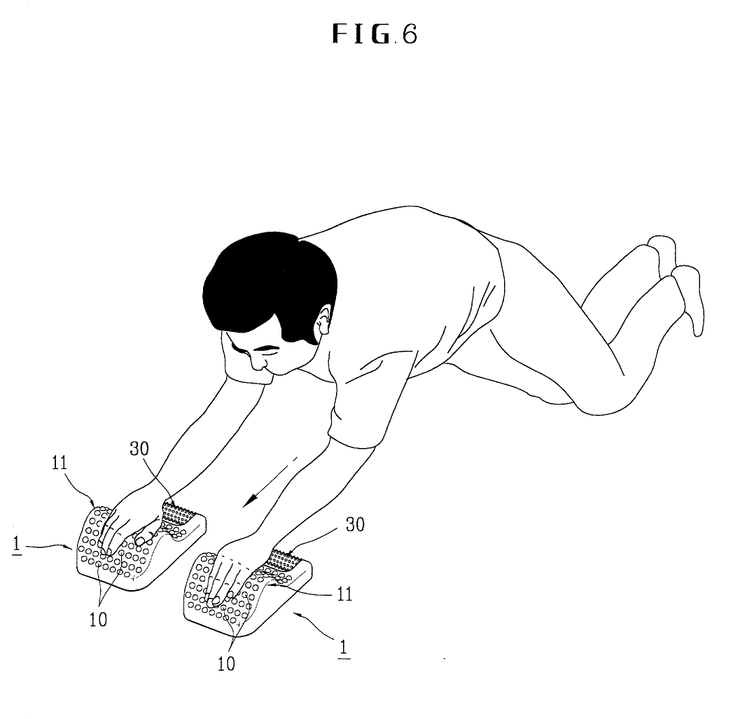

### DESCRIPTION OF THE PREFERRED EMBODIMENTS

The exercising tool for acupressure according to the present invention is an exercising tool 1 for acupressure, comprising: a curved surface 11 with a plurality of acupressure protuberances 10 on the upper side, a space 20 at one part of the curved surface 11, a gripe 30 being at one side of the space 30, being a circular rod 14 in shape and having a plurality of acupressure protuberances 31 made of nonferrous metal, two rollers 40, 40′ inserted into two inserting grooves 12, 12′ respectively at the lower side of the curved surface, and fixed with screws 60, 60′ and fixing strips 50, 50′; and a sliding control protuberance rod 13 at the lower side of the curved surface.

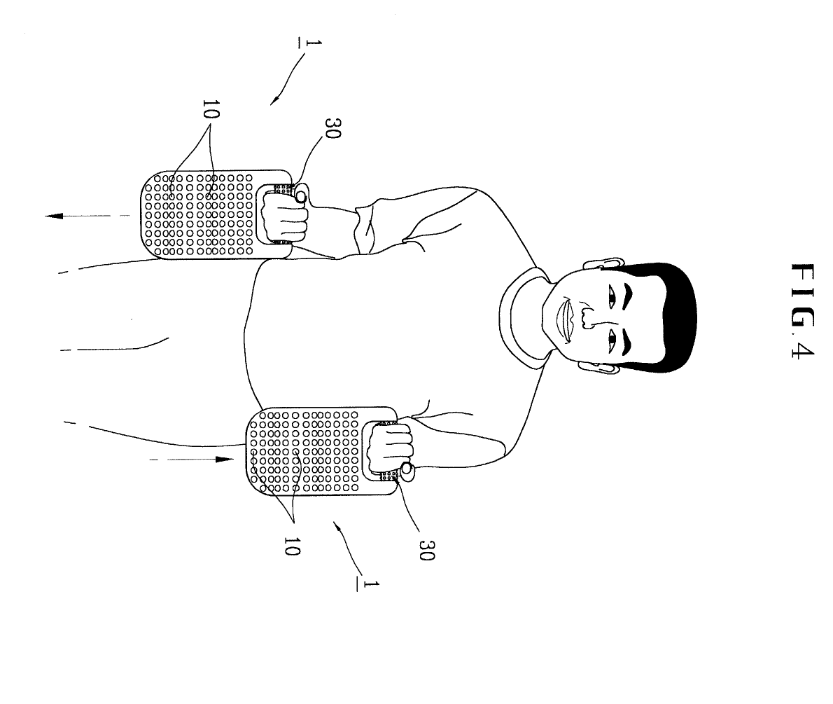

FIG. 4 shows an embodiment of the present invention. A user holds each gripe 30 of two exercising tools 1 with both hands, respectively, and lifts each exercising tools up and down by turns and reiterates it just like an calisthenic iron dumbbell. This kind of exercises offers the palms of the user pressure-stimulation effects due to a plurality of acupressure protuberances 31 of nonferrous metals and also provides arm exercise effects through reiteration of lifting the present exercising tools up and down.

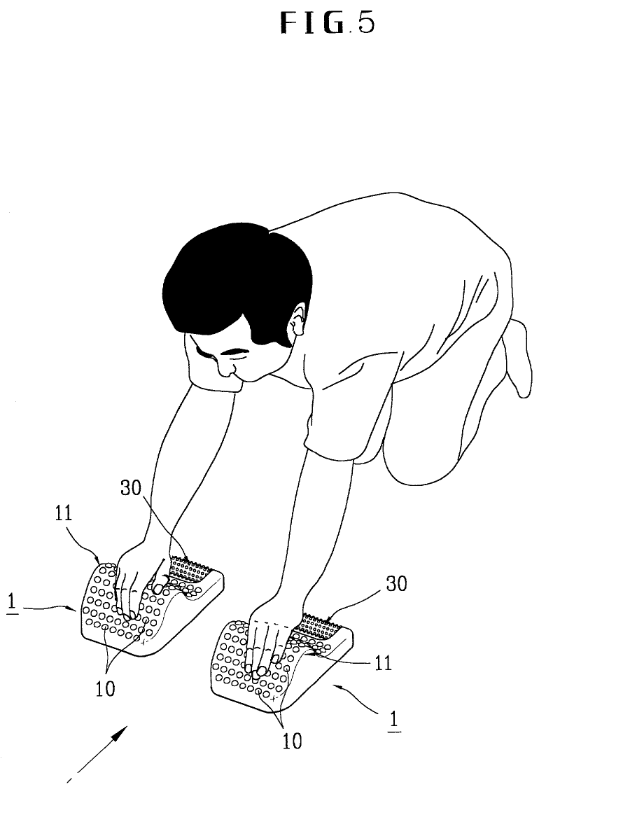

FIG. 5 shows another kind of embodiment of the present invention. A user keeps rolling the present tool forwardly and backwardly with both knees on the ground and each palm of the both hands on two curved surfaces 11 with a plurality of protuberances 10 of the present tool 1. According to the moves of the user, the rollers 40, 40′ inserted inside the upper side of the present tool move forwardly and backwardly on the ground.

This kind of forwardly and backwardly moving exercises offers the user effects of exercising the whole body including strengthening muscles of the stomach, the sides, the chest, the shoulders, etc. The present tool also provides the user with blood-circulation effects due to a plurality of protuberances 10 on the curved surface 11 during the exercises.

If the user wants to finish sliding exercises, the user pressures the rear of the exercising tool 1 slightly. And then the sliding control protuberance rod 13 at the lower side of the curved surface 11 contacts the ground and the present invention 1 stops sliding.

What is claimed is:

1. An Exercising tool for acupressure, comprising:
a curved surface with a plurality of acupressure protuberances on the upper side,
a space at one part of said curved surface,
a gripe being at one side of said space, said gripe being a circular rod in shape and having a plurality of acupressure protuberances made of nonferrous metals,
two rollers inserted into two inserting grooves respectively at the lower side of said curved surface, and said rollers being fixed with screws and fixing strips; and
a sliding control protuberance rod at the lower side of said curved surface.
